(19) United States
(12) Patent Application Publication
(10) Pub. No.: US 2022/0413174 A1
(43) Pub. Date: Dec. 29, 2022

(54) HYDROCARBON EXPLORATION METHOD

(71) Applicant: EQUINOR ENERGY AS, Stavanager (NO)

(72) Inventors: Mark Alan VAN SCHAACK, Colorado Springs, CO (US); Svend ØSTMO, Colorado Springs, CO (US)

(21) Appl. No.: 17/754,680

(22) PCT Filed: Nov. 3, 2020
(86) PCT No.: PCT/NO2020/050267

§ 371 Date: Apr. 8, 2022

(30) Foreign Application Priority Data
Nov. 4, 2019 (GB) 1916008.4

(51) Int. Cl. G01V 1/34; G01V 1/30

(52) U.S. Cl. CPC G01V 1/345; G01V 1/308; G01V 2210/6122; G01V 2210/74

(57) ABSTRACT

A method of exploring for hydrocarbons in a region, including the steps of obtaining seismic data for the region corresponding to two or more different times and analyzing the seismic data corresponding to the two or more different times to determine whether there are any changes in the seismic data.

The present invention relates to the field of hydrocarbon exploration. In particular, it relates to a method of exploring for hydrocarbons by analysing seismic data collected at different times.

Hydrocarbon exploration is typically a costly endeavour which involves much time spent looking for new locations of hydrocarbons. Thus, it would be desirable to find a better method for exploring for hydrocarbons.

The present invention provides a method of exploring for hydrocarbons in a region, the method comprising: (a) obtaining seismic data for the region corresponding to two or more different times (e.g. two or more different dates); and (b) analysing the seismic data corresponding to two or more different times to determine whether there are any changes in the seismic data.

There exists a great deal of seismic data collected about the regions around existing wells, e.g. for well-monitoring purposes. Much of this seismic data has been collected over a long time period such as a number of years. The present invention provides a way to exploit such data (or other, e.g. new data) to look for potential new locations of hydrocarbons within regions perhaps covered by existing data, but where it was not previously known that hydrocarbons were present.

In regions where, or close to where, there are hydrocarbon productions taking place, over time there is typically a decrease in the pressure of the region. In the event that there are any hydrocarbons present or remaining in that region, e.g. which have not (yet) been extracted, and whose existence may not previously have been known, these hydrocarbons may experience a corresponding pressure drop, which will in turn result in certain effects as described below.

Such a pressure drop may spread over a distance of tens of kilometres, for example.

When such a pressure drop occurs, this can cause various effects to occur such as gas cap expansion and gas coming out of (oil) solution.

Hydrocarbons in a gas phase are usually more clearly visible in seismic data than hydrocarbons in a liquid phase. Thus, if any of the above effects (e.g. gas cap expansion or compression or gas coming out of solution) occur, and can be seen in seismic data, then this can be an indication of a possible location of hydrocarbons, which may have not previously been known. Such hydrocarbons could, for example, be in a location close to, but a distance away from, an existing well. Looking for hydrocarbons in such regions, i.e. close to an existing well, can be more economically viable than looking in other regions because there can be existing infrastructure already present in or close to the region which may be utilised.

Thus, the present invention provides a way of looking for such effects in seismic data for a region corresponding to two or more different times (e.g. two or more different dates), to determine (e.g. by looking for an indicator of a possible presence of hydrocarbons) whether there may be (e.g. further) hydrocarbons in the region.

A region may be a subsurface volume corresponding to which seismic data (e.g. a seismic data set corresponding to a seismic survey) has been (or is) obtained.

The method comprises, at step (a), obtaining seismic data for the region corresponding to two or more different times (e.g. two or more different dates).

Some or all of the seismic data may comprise existing seismic data (e.g. without the need to perform a new seismic survey). Such existing seismic data may be “vintage” seismic data, as it is often referred to in this field. A vintage of seismic data refers to a previously recorded seismic data set, i.e. which was recorded (for a region) in the past. In some cases, the seismic data for a region corresponding to two or more different times (e.g. two or more different dates) may comprise two or more vintages of seismic data, e.g. seismic data which has been recorded in the past at two or more different times (e.g. two or more different dates).

The two or more vintages of seismic data, e.g. seismic data which has been recorded in the past at two or more different times (e.g. two or more different dates), need not necessarily both or all cover exactly the same region. For example, it may be sufficient for the two or more vintages of seismic data, e.g. seismic data which has been recorded in the past at two or more different times (e.g. two or more different dates), to cover an overlapping region, which could, for example, be smaller than a total region covered by one or more of the two or more vintages of seismic data.

Such existing seismic data as described above may be obtained or recovered from a memory (e.g. an archive), i.e. a location where it has (previously) been stored.

Alternatively or additionally, in some cases, a (e.g. new) seismic survey may be performed to obtain (e.g. some) (new) seismic data (e.g. corresponding to at least one (later) time). Such seismic data may then be compared to older, existing seismic data, such as described above.

Thus, the step of obtaining seismic data for the region corresponding to two or more different times (e.g. two or more different dates) may comprise obtaining that, or some of that (e.g. corresponding to at least one time), seismic data from one or more memories, and/or it may comprise performing one or more seismic surveys to obtain seismic data corresponding to at least one, or two or more, time(s).

The method also comprises, at step (b), analysing the seismic data corresponding to two or more different times (e.g. two or more different dates) to determine whether there are any changes in the seismic data. For example, changes in the seismic data, e.g. amplitude changes or seismic travel time delays, may indicate that gas cap expansion or compression and/or gas coming out of solution has occurred. As discussed above, this, in turn, can indicate a possible presence of hydrocarbons. Amplitude changes refer to a change in the seismic amplitude measured at a particular point in space. Seismic travel time delays refer to a change (increase) in the time taken for a seismic signal or wavefield to be propagated over an interval.

Thus, the method preferably comprises determining whether there are any changes in the seismic data (e.g. amplitude changes or seismic travel time delays) which are indicative of the presence of hydrocarbons. Changes in the seismic data which are indicative of the presence of hydrocarbons may comprise changes which are indicative of gas coming out of solution (from an oil phase) and/or gas cap expansion or compression.

The seismic data for the region corresponding to two or more different times may comprise so-called “four-dimensional seismic data”. “Four-dimensional seismic data” may also sometimes be referred to as “time lapse seismic data” or “repeat seismic data”. The term “four dimensional seismic data” means seismic data (which is usually three-dimensional seismic data) which has been or is acquired at different times (e.g. different dates, and at regular or irregular intervals) over a same area or region. Typically, in the prior art, this is done in order to assess changes in a producing hydrocarbon reservoir over time. Four-dimensional seismic data is typically acquired for a constant area or region, where source and receiver positions are ideally steered and/or controlled in such a way that the geometrical deviations between e.g. two different seismic acquisitions (surveys) are as small as operationally possible, e.g. in some cases to within 10-20 m. For example, a baseline survey is typically acquired where source and receiver locations are positioned as close as possible to predefined locations and where follow-up monitor surveys are acquired to repeat the baseline survey source and receiver locations as closely as possible.

However, the seismic data for the region corresponding to two or more different times (e.g. two or more different dates) need not necessarily comprise such four-dimensional seismic data as described above.

The seismic data for the region corresponding to two or more different times (e.g. two or more different dates) may additionally or alternatively (to the four-dimensional seismic data described above) comprise two- or three-dimensional seismic data. In contrast to four-dimensional seismic data as described above, such two or three-dimensional seismic data may not necessarily have been recorded for exactly the same area or region, and/or for the purpose for reservoir monitoring of producing hydrocarbon fields. However, at least some of the area or region should be a common area or region between the seismic data sets. In addition, such two or three-dimensional seismic data may not necessarily have been recorded with sources and/or receivers for the seismic data acquisition process in fixed positions and/or towing paths/directions. It is preferable that the seismic data is recorded with sources and/or receivers for the seismic data acquisition process in as close to the same positions and/or towing paths/directions as is operationally possible. However, if this is not the case, or not possible, then the (or some of the) seismic data may be preconditioned such that it can be compared with the rest of (or some of the rest of) the seismic data, .e.g. seismic data recorded at a different time. This is described in more detail below.

Seismic data for the region corresponding to one time (e.g. one date) may be referred to as a set of seismic data. Thus, the seismic data for the region corresponding to two or more different times (e.g. two or more different dates) may comprise at least a first seismic data set corresponding to a first time and a second seismic data set corresponding to a second time. The method may thus be said to comprise obtaining two or more sets of seismic data for the region corresponding to two or more different times (e.g. two or more different dates).

The method may comprise preconditioning at least one of the first and second seismic data sets, e.g. such that the first and second seismic data sets can be (or more easily/usefully/meaningfully be) compared. Such preconditioning can allow the sets of seismic data corresponding to two or more different times to be (or more easily/usefully/meaningfully be) compared. For example, a first set of seismic data corresponding to a first time may be preconditioned, or transformed, (e.g. to make it more similar to a second set of seismic data corresponding to a second time), such that it can be compared with a second set of seismic data corresponding to a second time. Thus, the preconditioning may turn (or transform) at least one of the at least two sets of seismic data into the same (or a similar or comparable) format as the other set(s) of seismic data, such that they can be compared. For example, preconditioning may comprise equalising one or more variables such as amplitude levels and/or a spectral bandwidth of the seismic data set(s). Such preconditioning can help to resolve issues with the seismic data sets not having been obtained and/or recorded in exactly the same way, such as receivers not being in exactly the same positions and/or sources not having the same towing path/direction.

However, preferably, the seismic data for the region corresponding to two or more different times (e.g. two or more different dates) are measured in the same or a sufficiently similar way, e.g. such that they can be compared. As such, preconditioning as described above may not be required. Measuring the seismic data corresponding to two or more different times in the same or a sufficiently similar way may comprise: controlling or driving a vessel for performing a seismic survey (e.g. a vessel towing one or more seismic sources), and/or towing one or more seismic sources, to obtain the seismic data in a same or similar direction and/or along a same or similar path; and/or using receivers located in the same or similar positions for detecting and recording the seismic data, such that, for example, source and receiver positions are ideally steered and/or controlled in such a way that the geometrical deviations between e.g. two different seismic acquisitions (surveys) are as small as operationally possible, e.g. in some cases to within 10-20 m. The receiver(s) may in some cases be located in fixed positions in or on the subsurface. Preferably, the source(s) is (are) towed in as similar a manner as possible, e.g. with regards to the receivers, to measure the seismic data corresponding to two or more different times.

Analysing the seismic data corresponding to two or more different times (e.g. two or more different dates) to determine whether there are any changes in the seismic data preferably comprises determining a difference between the seismic data corresponding to two or more different times. The difference may be determined by subtracting data of the first seismic data set from data of the second seismic data set or subtracting data of the second seismic data set from data of the first seismic data set. The difference between the seismic data corresponding to two or more different times may be a difference between the amplitude(s) and/or travel times of the seismic data sets.

It can be difficult to detect effects such as gas cap expansion or compression and/or gas coming out of solution in isolation, i.e. by looking at two (or more) sets of seismic data (measured at different times) separately or individually, as such effects tend to result in only relatively small changes in the seismic data. However, determining a difference between the seismic data corresponding to two or more different times can allow such effects to be more noticeable or apparent.

The method preferably comprises displaying the difference between the seismic data graphically. For example, the difference may be displayed on a graph whose axes correspond to a vertical and a horizontal direction. This can allow the existence of any significant difference to be identified more easily and e.g. noted or recorded.

The method also further comprises determining (at least partially) from the difference between the seismic data whether there is an indication of a possible presence of hydrocarbons in the region. This may be determined at least partially by eye, for example by looking at other features in the seismic data and deciding whether the difference may be consistent with gas cap expansion or compression and/or gas coming out of solution, e.g. as is known in the art. Any such determination may be validated (e.g. confirmed or contradicted) by making a model (e.g. a computer model) of fluid changes and/or movement in a layered or structural subsurface in order to make synthetic (simulated) seismic data that resembles the observed changes.

The method may further comprise, e.g. if there is an indication of a possible presence of (e.g. hitherto undiscovered) hydrocarbons in the region, making a decision about whether to explore for such hydrocarbons. This may depend on a number of factors such as whether there is any existing infrastructure (and, if so, its state), and/or the possible amount of hydrocarbons that may be present.

If a decision is taken to explore for such hydrocarbons, the method may then further comprise exploring for such hydrocarbons, e.g. by drilling.

The method preferably comprises, prior to step (a), deciding whether a region is a candidate for further analysis. This means that the further analysis may only be performed in cases (for regions) where there is suitable seismic data available and/or a likelihood of being able to observe an effect, such as gas cap expansion or compression and/or gas coming out of solution, should there be hydrocarbons in that region. This can help to avoid analyses being performed which are unlikely to be successful or helpful.

Deciding whether a region is a candidate for further analysis may comprise checking whether there is suitable seismic data on which the further analysis can be performed and/or checking whether the analysis would be likely to be able to identify a change or relevant effect such as gas cap expansion or compression and/or gas coming out of solution.

For example, deciding whether a region is a candidate for further analysis may comprise:

checking whether there is seismic data recorded at two or more different times for the region;

(ii) checking whether there is a sufficient amount of time (e.g. at least 1, 2, 3, 4 or 5 years) between the two or more different times;

(iii) checking whether the seismic data recorded at two or more different times is or may be (e.g. after preconditioning as described above) comparable;

(iv) checking whether there is a pressure depletion (or increase, e.g. following a start-up of injection) in the region;

(v) checking whether an initial pressure of the region is close (enough) to an estimated bubble point pressure; and/or

(vi) checking whether a gas cap may be present in the region.

Checks (i)-(iii) above relate to checking whether there is suitable seismic data available for the analysis to be performed on.

Checking whether the seismic data recorded at two or more different times is comparable may comprise checking whether the seismic data are measured in the same or a sufficiently similar way, e.g. as described above. Alternatively or additionally, this step may comprise checking whether it is possible to precondition (e.g. as described above) at least some of the seismic data (e.g. corresponding to one time) such that it can be can be compared to other seismic data (e.g. corresponding to another time). As such, the data as measured need not necessarily be comparable (although this is preferred), provided that the data (or some of the data) can be preconditioned or transformed such that it can be compared.

Checks (iv)-(vi) relate to checking whether or not it would be reasonable to expect a relevant effect such as gas cap expansion or compression and/or gas coming out of solution.

For example, it may be required that the initial pressure of the region must be close enough to a bubble point (an estimated bubble point pressure) that a pressure drop which occurs in the region is sufficient to move the pressure of the region to below the bubble point, e.g. such that an effect of gas coming out of solution may be observed/occur.

The initial pressure of the region may be an initial pore pressure of the hydrocarbon fluid(s) in the region, which may be obtained from data from nearby wells, where this is estimated while/after drilling.

The estimated bubble point pressure may be determined from laboratory measurements on hydrocarbon fluid samples obtained in nearby wells.

Alternatively or additionally, it may be required that the pressure drop (or increase) is sufficiently large such that a gas cap expansion (or compression) may be observed (e.g. a gas cap expansion or compression is sufficiently large that it may be observed, e.g. on a graph).

In some cases, a pressure drop of between 5 and 15 bar may be sufficient to observe an effect such as gas coming out of solution, or gas cap expansion, or, in some cases, a larger pressure drop may be required.

The method may further comprise assigning to a region an indicator indicating how good a candidate for further analysis the region is. This could be a colour or number indicator, for example. The indicator could be based for example, on one or more (and preferably all) of checks (iv)-(vi) above, for example.

The method may then further comprise displaying the indicator on a map. This can allow possible regions for further analysis to be viewed graphically and it may then be easier to make a decision about which region(s) to analyse.

The above method is preferably, at least partially, performed on a computer or computer system.

A further aspect of the invention relates to a computer program product comprising computer readable instructions that, when run on a computer, is configured to cause one or more processers to perform the method described above.

A further aspect of the invention relates to a system for exploring for hydrocarbons, the system comprising one or more software elements arranged to perform the method described above.

A system may comprise one or more memories and one or more processors configured to perform the method(s) as described above. The one or more memories may store data used as an input to the method (e.g. seismic data) and/or data output from the method. The one or more processors may be programmed with software (e.g. computer program(s)) which causes them to perform the method of the present invention. The system may comprise one or more screens and/or data input means, e.g. for a user to control the performing of the method and/or view an output of the method on a screen.

For greater speed and efficiency, the method, or at least part of the method, is preferably performed on, or implemented by, a computer.

The methods in accordance with the present invention may be implemented at least partially using software e.g. computer programs. It will thus be seen that when viewed from further aspects, the present invention provides computer software specifically adapted to carry out the methods herein described when installed on data processing means (e.g. one or more processors), a computer program element comprising computer software code portions for performing the methods herein described when the program element is run on data processing means, and a computer program comprising code means adapted to perform all the steps of a method or of the methods herein described when the program is run on a data processing system. The data processor may be a microprocessor system, a programmable FPGA (field programmable gate array), etc.

The invention also extends to a computer software carrier comprising such software which when used to operate a processor or microprocessor system comprising data processing means causes in conjunction with said data processing means said processor or system to carry out the steps (or one or more of the steps) of the methods of the present invention. Such a computer software carrier could be a physical storage medium such as a ROM chip, RAM, flash memory, CD ROM or disk, or could be a signal such as an electronic signal over wires, an optical signal or a radio signal such as to a satellite or the like.

It will be appreciated that in some embodiments, not all steps of the methods of the invention need be carried out by computer software and thus from a further broad aspect the present invention provides computer software and such software installed on a computer software carrier for carrying out at least one of the steps of the methods set out herein.

The present invention may accordingly suitably be embodied as a computer program product for use with (or within) a computer system. Such an implementation may comprise a series of computer readable instructions fixed on a tangible medium, such as a non transitory computer readable medium, for example, diskette, CD ROM, ROM, RAM, flash memory or hard disk. It could also comprise a series of computer readable instructions transmittable to a computer system, via a modem or other interface device, either over a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre loaded with a computer system, for example, on a system ROM or fixed disk, or distributed from a server or electronic bulletin board over a network, for example, the Internet or World Wide Web.

Preferred embodiments of the invention will now be described by way of example only and with reference to the accompanying drawings, in which:

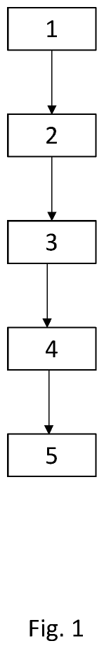

FIG. 1 is a flow chart illustrating the key steps of an embodiment of the method;

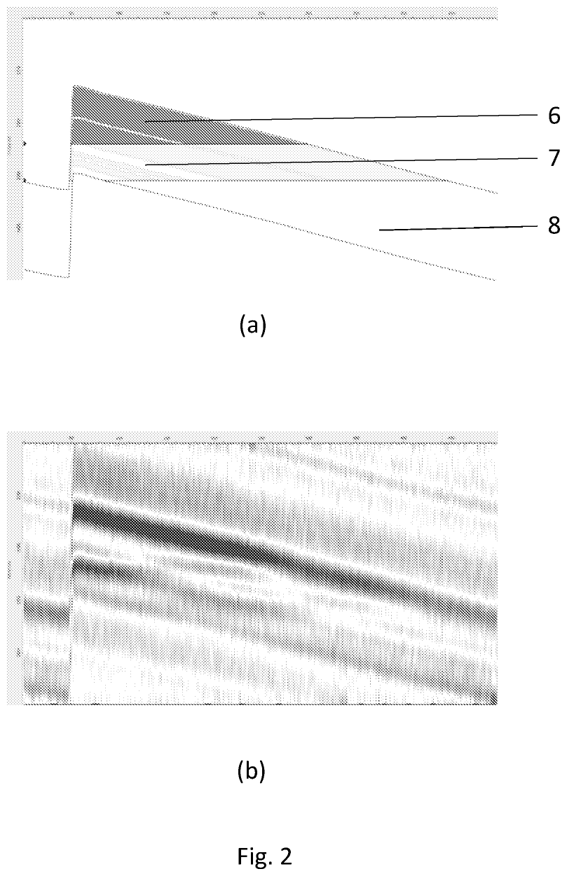

FIG. 2(a) is a plot illustrating a model of a subsurface structure with water, oil and gas cap regions;

FIG. 2(b) is a plot illustrating simulated seismic data for the model of FIG. 2(a);

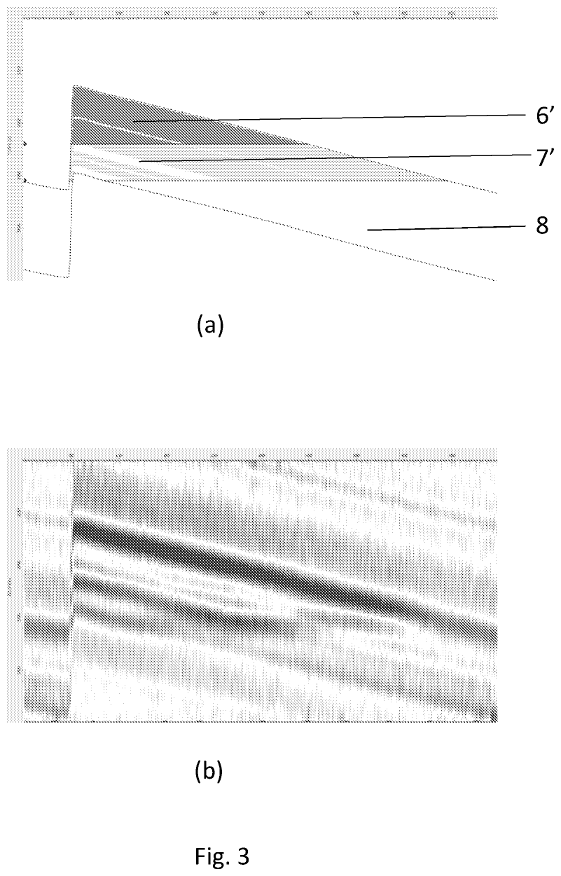

FIG. 3(a) is a plot illustrating a model of a subsurface structure with water, oil and gas cap regions where gas has come out of solution in the oil phase resulting in 10% of the pore volume available for fluid fill now being filled with gas compared to that in FIG. 2(a);

FIG. 3(b) is a plot illustrating simulated seismic data for the model of FIG. 3(a); and

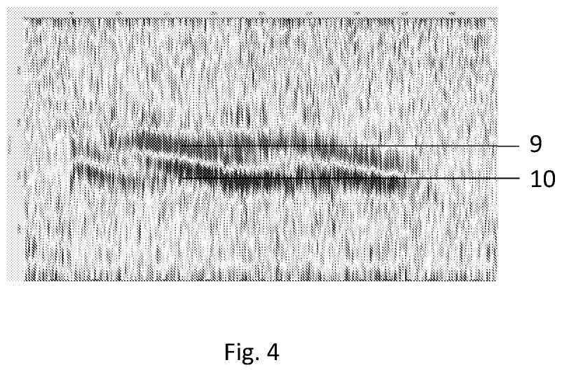

FIG. 4 is a comparison plot showing the difference between the plots of FIG. 2(b) and FIG. 3(b).

The present invention provides a method of exploring for hydrocarbons by analysing seismic data for a region collected at different times.

FIG. 1 is a flow chart illustrating an embodiment of a method of the present invention. The method comprises five steps 1-5 as shown in the chart.

At step 1, it is determined whether a particular region is a candidate for further analysis. If it is determined that the region is a candidate, then the further steps of the method are performed. If not, then the method stops at step 1 in such a case.

At step 2, the seismic data sets on which the analysis is to be performed are obtained. The data (or some of the data) could be obtained from memory or it could be measured (e.g. if not already present in a memory). The seismic data is seismic data corresponding to (or recorded at) two or more different times.

At step 3, the seismic data corresponding to two or more different times is compared and a comparison plot of the seismic data is produced. In some embodiments, e.g. if 3D data is being compared, a difference cube is produced. In other embodiments, e.g. if 2D data is being compared, a difference section is produced. In other embodiments, alternative means of displaying the comparison are produced.

At step 4, the comparison plot (or other means of displaying the comparison) is analysed and it is determined whether the plot (or other means of displaying the comparison) indicates the possibility of the presence of hydrocarbons.

At step 5, based on the outcome of step 4 (and possibly further studies or checks), it is decided whether to physically explore and/or drill for hydrocarbons in the region.

Each of the steps 1-5 will now be described in more detail.

Step 1 involves determining whether a particular region is a candidate for further analysis.

Step 1 involves a number of sub-steps.

First, step 1 involves checking whether there is seismic data recorded at two or more different times for the region. The seismic data could comprise four-dimensional seismic data spanning a (sufficiently long) time period, four-dimensional seismic data and three-dimensional seismic data recorded at a different time to the four-dimensional seismic data, or two or more three-dimensional seismic data sets (seismic surveys), i.e. taken at different times.

If such seismic data recorded at two or more different times is found, then it is checked whether the seismic data is comparable, i.e. whether the seismic data are measured in the same or a sufficiently similar way, such that their data can be meaningfully and easily compared. For example, it may be required that source and receiver positions are steered and/or controlled in such a way that the geometrical deviations between e.g. two different seismic acquisitions (surveys) are as small as operationally possible, e.g. in some cases to within 10-20 m.

If a region is found which fulfils these criteria (i.e. there are two or more comparable seismic data sets), then it is also determined whether there is a sufficient likelihood of there being a signal indicating the presence of hydrocarbons following the rest of the method.

In order to determine this, it can be checked whether the initial pressure (or an estimated pressure) of the region at the time (or close to the time) at which the earlier/earliest seismic data was recorded is close to the estimated bubble point pressure.

The initial pressure of the region is an initial pore pressure of the hydrocarbon fluid(s) in the region, which may be obtained from data from nearby wells, where this is estimated while/after drilling.

The estimated bubble point pressure is determined from laboratory measurements on hydrocarbon fluid samples obtained in nearby wells.

The pressure difference (e.g. drop) between the times of the later and earlier seismic data is also determined or estimated (e.g. from sources such as exploration wells, pressures in different, but close fields etc.). The greater the pressure difference or drop, the more likely a useful signal could be obtained from analysis of the seismic data.

If the difference between the pressure corresponding to the time of the earlier/earliest seismic data and the pressure of bubble point is relatively small, e.g. when compared to the pressure difference (drop) between the times of the later and earlier seismic data, then this would indicate the possibility of gas coming out of solution. If the possibility of gas coming out of solution is indicated then this would suggest that it would be worthwhile performing the analysis of the seismic data sets of the region.

The pressures referred to above can be obtained or estimated from exploration (e.g. from prospect information), petroleum technology development data or production history and well logs, for example.

As an alternative, or in addition to checking whether the pressure of a region is close to its bubble point, it can be checked whether there is a gas cap present, e.g. by looking at or analysing the initial seismic data. If such a gas cap is present, then a reduction in pressure would result in an increase in the size of the gas cap, and this could indicate the presence of hydrocarbons.

Thus, a region may be indicated as being a candidate for further analysis if it has a pressure (e.g. a pressure at the time of the earlier/earliest seismic data) close to its bubble point (e.g. sufficiently close that the effect of gas coming out of solution may occur given the pressure drop), an initial gas cap, or both.

In order to illustrate how it may be decided whether a region is a candidate for further analysis, three examples are presented below. In these examples, Pᵢₙᵢₜ is the estimated initial pressure of the hydrocarbons in the region, P_{bubblepoint} is the estimated bubble point pressure, and the pressure depletion is the difference in the estimated pressure of the region between the earliest and latest (or earlier and later) data sets.

### EXAMPLE 1

Pᵢₙᵢₜ P_{bubble point}=5 bar
(ii) Pressure depletion=10 bar
(iii) No gas cap present
   In this example, although there is no gas cap present and the pressure depletion is not that high, the initial pressure is relatively close to the bubble point pressure so the region is indicated as being a (good) candidate for further analysis.

### EXAMPLE 2

(i) Pᵢₙᵢₜ P_{bubble point}=50 bar

(ii) Pressure depletion=10 bar

(iii) No gas cap present

In this example, the initial pressure is not that close to the bubble point pressure, the pressure depletion is not that high and there is no gas cap present. As such, this region is not indicated as being a candidate for further analysis.

### EXAMPLE 3

(i) Pᵢₙᵢₜ P_{bubble point}=50 bar

(ii) Pressure depletion=3 bar

(iii) Gas cap present In this example, the initial pressure is not that close to the bubble point pressure and the pressure depletion is not that high but there is a gas cap present. As such, this region is indicated as being a (possible) candidate for further analysis.

In one embodiment, regions are colour-coded (e.g. green for good candidates, yellow for possible candidates and red for not being a candidate) to indicate whether they are a candidate further analysis and the colour coded regions are displayed on a map.

If a region is indicated as being a candidate for further analysis, as determined at step 1 described above, then, at step 2, the seismic data sets on which the analysis is to be performed are obtained.

The data (or some of the data) could be obtained from memory or it could be measured (e.g. if new or newer seismic data is required). The seismic data is seismic data corresponding to (or recorded at) two or more different times.

For example, the seismic data sets could be two (or more) separate 3D seismic data sets. Such sets could all be obtained from memory (i.e. be previously recorded data) or the latest data set could be measured, e.g. for the method of the present invention to be performed.

The seismic data sets could be seismic data measured from any known or standard method, for example. In some cases, the seismic data could be recorded with air guns.

In some embodiments where 3D seismic data sets are used, such data sets can be preconditioned before they are analysed. Such preconditioning can help to ensure that the data sets being used are comparable with each other.

Preconditioning can entail equalising one or more variables such as amplitude levels and/or a spectral bandwidth of the seismic data set(s).

FIG. 2(a) is a 2D representation of a model of a geological structure comprising a region of water 8, a region of oil 7 and a region of gas (a gas cap) 6. The x-axis represents horizontal position and the y-axis represents depth.

FIG. 2(b) shows simulated seismic data for the model of FIG. 2(b), such as would be obtained at step 2.

FIG. 3(a) is a 2D representation of a model of a geological structure corresponding to that of FIG. 2(a) but at a later time, comprising a (unchanged) region of water 8, a region of oil 7′ and a region of gas (a gas cap) 6′. The x-axis represents horizontal position and the y-axis represents depth. In this case, due to a reduction of pressure, gas has come out of solution in the oil phase resulting in 10% of the pore volume available for fluid fill now being filled with gas compared to the case in FIG. 2(a).

FIG. 3(b) shows simulated seismic data for the model of FIG. 3(b), such as would be obtained at step 2.

In FIGS. 2(b), 3(b) and 4, the red (darker grey) shading corresponds to negative values and the blue (lighter grey) shading corresponds to positive values.

After the seismic data has been obtained, at step 3, the seismic data corresponding to two or more different times is compared by determining the difference between the later and earlier seismic data, e.g. by subtracting the later seismic data from the earlier seismic data, or vice versa, and a comparison plot (or other means of displaying the comparison) of the seismic data (i.e. showing this difference) is produced. This is illustrated in the plot in FIG. 4, which shows the difference between the data in FIGS. 2(b) and 3(b).

Next, at step 4, the comparison plot (or other means of displaying the comparison) is analysed, e.g. by eye, and it is determined whether the plot (or other means of displaying the comparison) indicates the possibility of the presence of hydrocarbons.

For example, in FIG. 4, the presence of the two bands 9 and 10 clearly indicates that there has been a change between the two plots 2(b) and 3(b). This in turn indicates the possible presence of hydrocarbons. On the other hand, if it is found that no such bands or features are present, this would indicate that there had not been any change as a result of a pressure drop, and this would in turn suggest that it is much less likely that hydrocarbons are present.

Finally, at step 5, based at least partially on the outcome of step 4, it is decided whether to physically explore and/or drill for hydrocarbons in the region. This may, for example, be based on other factors as well as the outcome of step 4, such as the presence or lack of any existing infrastructure, and the size of the region concerned.

Alternatively or additionally, before performing step 5, any observed effect (e.g. suggesting the presence of gas coming out of solution or gas cap expansion or compression) is ideally studied and it would be attempted to formulate a hypothesis as to why such an effect (e.g. as observed in a difference plot) is observed. Based on that, an assessment of whether the observed effect is a likely hydrocarbon indicator may be performed.

1. A method of exploring for hydrocarbons in a region, the method comprising:
(a) obtaining seismic data for the region corresponding to two or more different times;
(b) analysing the seismic data corresponding to two or more different times to determine whether there are any changes in the seismic data; and
(c) determining whether there are any changes in the seismic data which are indicative of the presence of hydrocarbons, wherein changes in the seismic data which are indicative of the presence of hydrocarbons comprise changes which are indicative of gas coming out of an oil phase solution and/or a gas cap expansion or compression.

2. (canceled)

3. (canceled)

4. A method as claimed in claim 1, wherein the seismic data for the region corresponding to two or more different times comprises at least a first seismic data set corresponding to a first time and a second seismic data set corresponding to a second time, the method further comprising preconditioning at least one of the first and second seismic data sets.

5. A method as claimed in claim 1, wherein the seismic data for the region corresponding to two or more different times are measured in a sufficiently similar way such that the seismic data for the region corresponding to two or more different times can be compared.

6. A method as claimed in claim 1, wherein the seismic data for the region corresponding to two or more different times comprises at least a first seismic data set corresponding to a first time and a second seismic data set corresponding to a second time, and wherein analysing the seismic data comprises subtracting data of the first seismic data set from data of the second seismic data set or subtracting data of the second seismic data set from data of the first seismic data set to determine a difference between the data of the first and second seismic data sets.

7. A method as claimed in claim 6, further comprising displaying the difference between the seismic data graphically.

8. A method as claimed in claim 6, further comprising determining at least partially from the difference whether there is an indication of a possible presence of hydrocarbons in the region.

9. A method as claimed in claim 8, further comprising, if there is an indication of a possible presence of hydrocarbons in the region, making a decision about whether to explore for such hydrocarbons.

10. A method as claimed in claim 9, further comprising exploring for such hydrocarbons.

11. A method as claimed in claim 1, further comprising, prior to step (a), deciding whether a region is a candidate for further analysis.

12. A method as claimed in claim 11, wherein deciding whether a region is a candidate for further analysis comprises:
(i) checking whether there is seismic data recorded at two or more different times for the region;
(ii) checking whether there is a sufficient amount of time between the two or more different times;
(iii) checking whether the seismic data recorded at two or more different times is comparable, or may be preconditioned or transformed such that it is comparable;
(iv) checking whether an estimated initial pressure of the region is sufficiently close to an estimated bubble point pressure;
(v) checking whether there is a sufficient pressure depletion in the region; and/or
(vi) checking whether a gas cap may be present in the region.

13. A method as claimed in claim 12, further comprising assigning to a region an indicator indicating how good a candidate for further analysis the region is.

14. A method as claimed in claim 13, further comprising displaying the indicator on a map.

15. A computer program product comprising computer readable instructions that, when run on a computer, is configured to cause one or more processers to perform the method of claim 1.

16. A system for exploring for hydrocarbons, the system comprising one or more software elements arranged to perform the method of claim 1.

17. A method as claimed in claim 1, further comprising, if there are changes in the seismic data, identifying potential new locations of hydrocarbons based on the changes in the seismic data.
